(19) United States
(12) Patent Application Publication
(10) Pub. No.: US 2010/0153420 A1
(43) Pub. Date: Jun. 17, 2010

(54) DUAL-STAGE REGULAR EXPRESSION PATTERN MATCHING METHOD AND SYSTEM

(75) Inventors: Chang-Ching Yang, Taipei (TW); Sheng-De Wang, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/398,484

(22) Filed: Mar. 5, 2009

(30) Foreign Application Priority Data
Dec. 15, 2008 (TW) 097148701

(51) Int. Cl. G06F 17/30

(52) U.S. Cl. 707/758; 707/E17.039

(57) ABSTRACT

A dual-stage regular expression pattern matching method and system is proposed, which is designed for integration to a data processing system, such as a computer platform, a firewall, a network intrusion detention system (NIDS), or a DNA sequence analysis system, for checking whether an input code sequence (such as a network data packet) is matched to specific patterns predefined by regular expressions. The proposed system and method includes a first-stage comparison procedure for comparison of the prefix string of each input code sequence and a second-stage comparison procedure for comparison of the postfix string of the same input code sequence. This feature can be used for processing code sequences having a special pattern without producing an enormous amount of state data that would cause the problem of insufficient memory during operation.

### BACKGROUND OF THE INVENTION

1. Field of the Invention

This invention relates to information technology, and more particularly, to a dual-stage regular expression pattern matching method and system which is designed for integration to a data processing system, such as a firewall or a network intrusion detention system (NIDS), for checking whether an input code sequence (such as a network data packet) is matched to specific patterns predefined by regular expressions.

2. Description of Related Art

In the application of computer network systems, how to prevent the intrusion of hackers or malicious programs is an important research effort in the information industry. Presently, firewalls and NIDS (network intrusion detention system) are the most widely utilized technologies for this purpose. In operation, each incoming and outgoing network data packet is scanned to check whether its pattern is matched to the pattern of a known packet from a hacker or malicious program. If matched, then the network data packet is blocked or discarded from entering into the network system.

In practice, present network systems typically utilize regular expressions for description of the packet data patterns of known hackers or malicious programs. This regular expression based approach is implemented with a deterministic finite-state automata (DFA) machine for the pattern matching.

For performance enhancement purpose, conventional regular expression pattern matching methods are typically based on a one-pass scan approach for processing the input network data packets. This one-pass scan approach requires the appending of a 2-character pattern, namely [.*], at the front of each regular expression, such that each time a character is fetched and compared by the DFA, it allows the next state transition to have a deterministic state. The benefit of this approach is that it can help prevent the same state from being repetitively produced and thus causing a nondeterministic processing result.

One drawback to the above-mentioned one-pass scan approach, however, is that it is unsuitable for use to process regular expressions of a special pattern, namely “ABC.{n}T”. This is because that the repetition descriptor {n} in this kind of pattern would undesirably result in an exponential growth of the total number of state values (in some cases, up to several billions of bytes in amount), thus causing the problem of insufficient memory during operation.

### SUMMARY OF THE INVENTION

It is therefore an objective of this invention to provide a dual-stage regular expression pattern matching method and system which can be used for processing regular expressions of the special pattern “ABC.{n}T” without resulting in an enormous amount of state data that would cause the problem of insufficient memory during operation.

In application, the dual-stage regular expression pattern matching method and system according to the invention is designed for integration to a data processing system, such as a computer platform, a firewall, a network intrusion detention system (NIDS), or a DNA sequence analysis system, for checking whether an input code sequence (such as a data string, a network data packet, or a DNA sequence) is matched to specific patterns predefined by a set of regular expressions.

In architecture, the dual-stage regular expression pattern matching method and system according to the invention comprises: (A) a first-stage processing unit; and (B) a second-stage processing unit; wherein the first-stage processing unit includes: (A1) a sequential-scan prefix string extraction module; and (A2) a prefix string comparison module; while the second-stage processing unit includes: (B1) a postfix string extraction module; and (B2) a postfix string comparison module.

In operation, the dual-stage regular expression pattern matching method and system of the invention includes a first-stage comparison procedure for checking whether the prefix string of each input code sequence is matched to the prefix string of a predefined regular expression, and a second-stage comparison procedure for checking whether the postfix string of the same input code sequence is matched to the postfix string of the prefix-matched regular expression. This feature can be used for processing code sequences having the special regular expression pattern “ABC.{n}T” without producing an enormous amount of state data that would cause the problem of insufficient memory during operation.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an example of the application of the invention with a data processing system;

FIG. 2 is a schematic diagram showing the I/O functional model of the invention;

FIG. 3 is a schematic diagram showing the basic data structure of a regular expression database;

FIG. 4 is a schematic diagram showing a modularized architecture of the system implementation of the invention;

FIG. 5 is a schematic diagram showing the basic data structure of a hash table utilized by the invention;

FIG. 6 is a schematic diagram showing the internal architecture of the postfix string comparison module utilized by the invention in the case of implementation with DFA;

FIG. 7 is a schematic diagram showing an example of the internal architecture of one single processing unit in the postfix string comparison module shown in FIG. 6.

### DETAILED DESCRIPTION OF PREFERRED EMBODIMENTS

The dual-stage regular expression pattern matching method and system according to the invention is disclosed in full details by way of preferred embodiments in the following with reference to the accompanying drawings.

### Application and Function of the Invention

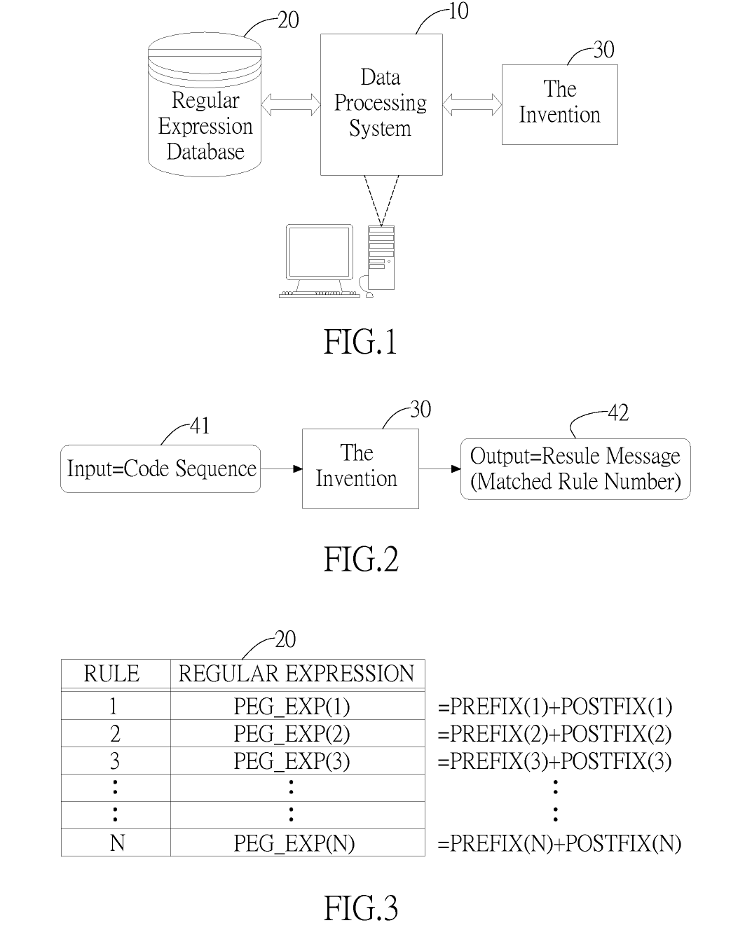

FIG. 1 shows an example of the application of the dual-stage regular expression pattern matching system of the invention (which is here encapsulated in a box labeled with the reference numeral 30). As shown, in this application example, the dual-stage regular expression pattern matching system of the invention 30 is integrated to a data processing system 10, such as a computer platform, a firewall, a network intrusion detention system (NIDS), or a DNA (deoxyribonucleic acid) sequence analysis system, for providing a dual-stage regular expression pattern matching function for the data processing system 10.

FIG. 2 shows the I/O (input/output) functional model of the dual-stage regular expression pattern matching system of the invention 30. As shown, the invention is used for processing an input of a code sequence 41 with the purpose of checking whether the pattern of the input code sequence 41 is matched to one or more specific patterns that are predefined by a set of regular expressions in a regular expression database 20; and the end processing result is outputted as a result message 42 which shows the match/unmatch status of the input code sequence 41 and, if the result is a match, further indicates which regular expression in the regular expression database 20 is matched to the input code sequence 41.

The result message 42 is then returned to the data processing system 10 for the data processing system 10 to respond by performing a corresponding action on the code sequence 41. For example, if the input code sequence 41 is a network data packet originated from a hacker, the corresponding action might be to discard or block the data packet from entering the network system.

In practical applications, for example, the input code sequence 41 can be either a data string, a network data packet, or a DNA sequence. For example, in the application with a computer platform, the invention can be used for checking whether an input data string supplied by a user trying to log in to the computer platform is a valid and authorized username or password. In the application with a firewall or NIDS, the invention can be used for checking whether an incoming network data packet is originated from a hacker or malicious virus. In the application with a DNA sequence analysis system, the invention can be used for checking the type of a DNA sequence.

Fundamentally, the invention is specifically designed for processing code sequences of a special pattern of concern as described by the following regular expression:

α.{n}β

where
α represents a string (hereinafter referred to as “prefix string”);
. represents a character;
{n} represents a string of n repetitions of the preceding character;
β represents a string or a regular expression (the string “.{n}β” is hereinafter referred to as “postfix string”).
   In practice, application engineers can prescribe all patterns that are matched to the above regular expression to the regular expression database 20. FIG. 3 shows the basic data structure of the regular expression database 20, which contains a user-defined set of N regular expressions, expressed as REG_EXP(1), REG_EXP(2), . . . , and REG_EXP(N), where each regular expression is associated with a rule number. For example, the first regular expression REG_EXP(1) is associated with the rule number 1; the second regular expression REG_EXP(2) is associated with the rule number 2; and so forth. Further, each regular expression is divided into two parts: a prefix string and a postfix string. For example, the first regular expression REG_EXP(1) is divided into a prefix string PREFIX(1) and a postfix string POSTFIX(1); the second regular expression REG_EXP(2) is divided into a prefix string PREFIX(2) and a postfix string POSTFIX(2); and so forth.

For example, regular expressions predefined in the regular expression database 20 may include “LOGIN[̂\X0a]{100}” or “ABC[̂\n]{10}T”; where “LOGIN[̂\x0a]{100}” has “LOGIC” as prefix string and [̂\x0a]{100} as postfix string, while “ABC[̂\n]{10}T” has “ABC” as prefix string and “[̂\n]{10}T” as postfix string.

### Architecture of the Invention

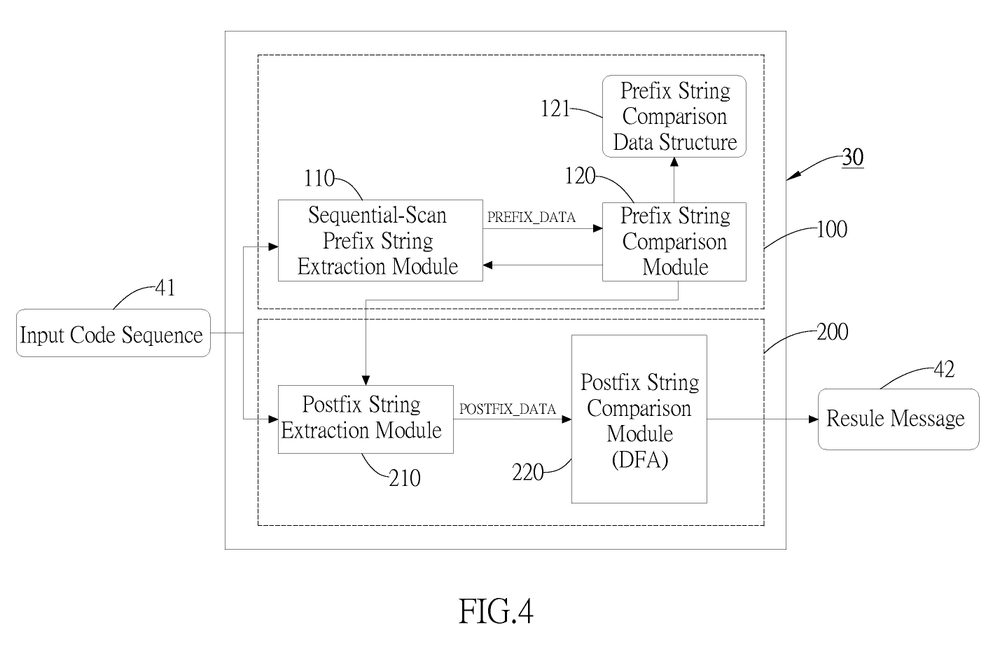

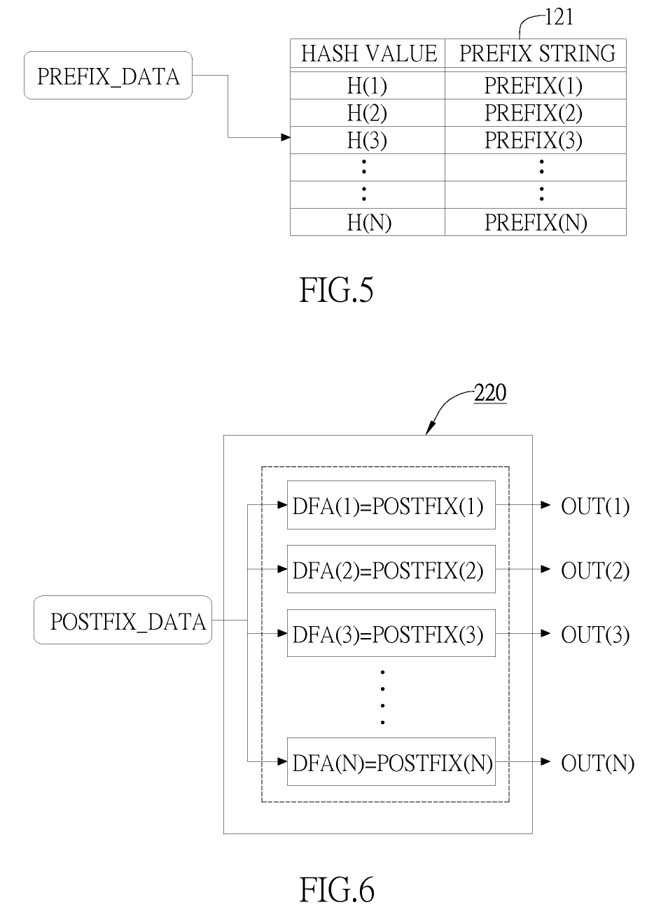

As shown in FIG. 4, in architecture, the dual-stage regular expression pattern matching system of the invention 30 comprises: (A) a first-stage processing unit 100; and (B) a second-stage processing unit 200; wherein the first-stage processing unit 100 includes: (A1) a sequential-scan prefix string extraction module 110; and (A2) a prefix string comparison module 120; while the second-stage processing unit 200 includes: (B1) a postfix string extraction module 210; and (B2) a postfix string comparison module 220. Firstly, the respective attributes and functions of these constituent system components of the invention are described in details in the following.

### (A1) Sequential-Scan Prefix String Extraction Module 110

The sequential-scan prefix string extraction module 110 is capable of extracting the prefix string of the input code sequence 41 (the extracted prefix string is here expressed as PREFIX_DATA) by a sequential-scan process.

In function, the sequential-scan prefix string extraction module 110 operates in such a manner as to sequentially scan the input code sequence 41 for a fixed string length L from the start of the input code sequence 41, and the result of each scan is used as a keyword and transferred to the prefix string comparison module 120 for comparison. The fixed string length L can be arbitrarily chosen from the range between 2 and L_{MAX}, where L_{MAX} is the maximum prefix string length among all the prefix strings in the regular expression database 20. For example, if “LOGIN” has the maximum string length among all the prefix strings in the regular expression database 20, then L_{MAX}=5 since the string “LOGIN” has 5 characters.

For example, in the case that L is set to 5 and the input code sequence 41 is “abcLOGIN000 . . . 000” (one hundred 0s following the string “abcLOGIN”), then the sequential-scan prefix string extraction module 110 will first scan the input code sequence 41 for the first 5 characters (in this case, “abcLO” is extracted), and then transfer the extracted string “abcLO” to the prefix string comparison module 120 for comparison. If the result is a mismatch, then the sequential-scan prefix string extraction module 110 will scan for the next 5 characters (in this case, “bcLOG” is extracted). The same procedure is repeated until the extracted string is determined to be a match by the prefix string comparison module 120 (in this case, until “LOGIN” is extracted).

### (A2) Prefix String Comparison Module 120

The prefix string comparison module 120 includes a prefix string comparison data structure 121 which is predefined by application engineers in accordance with the regular expression database 20. In operation, the prefix string comparison module 120 is capable of using this prefix string comparison data structure 121 for comparing whether the prefix string extracted by the sequential-scan prefix string extraction module 110 is a match to any of the prefix strings defined by the regular expressions in the regular expression database 20. If the processing result is a match, then the second-stage processing unit 200 will be activated to perform a second-stage process for postfix string comparison.

In practice, for example, the prefix string comparison data structure 121 can be implemented with a hash table or a binary search tree (BST). However, since the binary search tree has a relatively poor performance, the utilization of the hash table is more preferable to offer better processing speed.

In the case of using the hash table, for example, if the regular expression database 20 defines “ABC[̂\n]{10}T” as the pattern of a packet from a hacker or malicious virus program, then the prefix string “ABC” can be converted to a hash value, and the hash value is used by the hash table for lookup of the prefix string “ABC”. Since the hash table is well known and widely utilized data structure in the information industry, details thereof will not be further described in this specification.

### (B1) Postfix String Extraction Module 210

The postfix string extraction module 210 is capable of extracting the postfix string of the input code sequence 41 (the extracted postfix string is here expressed as POSTFIX_DATA), and then transferring the extracted postfix string POSTFIX_DATA to the postfix string comparison module 220 for comparison.

### (B2) Postfix String Comparison Module 220

The postfix string comparison module 220 is capable of performing a postfix string comparison process after the prefix string of the input code sequence 41 is determined to be a match by the prefix string comparison module 120, i.e., comparing whether the postfix string of the input code sequence 41 is a match to any one of the regular expressions predefined in the regular expression database 20. The processing result is outputted as a result message 42. If the processing result is a mismatch, then the result message 42 is simply a mismatch message; and whereas if a match, then the result message 42 indicates the corresponding rule number of the matched regular expression.

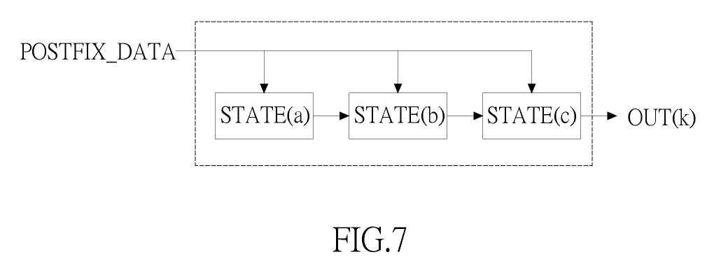

In practice, for example, the postfix string comparison module 220 can be implemented with a conventional deterministic finite-state automata (DFA) or a nondeterministic finite-state automata (NFA) machine. An example of the implementation with DFA is shown in FIG. 6 and FIG. 7. The DFA logic circuit shown in FIG. 6 includes an array of N state transition processing units DFA(1), DFA(2) . . . , and DFA(N) corresponding to the N postfix strings POSTFIX(1), POSTFIX(2) . . . , and POSTFIX(N) defined in the regular expression database 20.

In operation, for example, if the (k)th state transition processing unit DFA(k) represents the pattern “abc”, then its internal logic circuit architecture includes 3 state unit STATE(a), STATE(b), and STATE(c) as illustrated in FIG. 7. In operation, when the first state unit STATE(a) receives the data “a”, then its output port will generate a logic-HIGH signal for enabling the second state unit STATE(b); and subsequently if the enabled second state unit STATE(b) receives the data “b” in the next cycle, then it will generate an output of a logic-HIGH signal for enabling the third state unit STATE(c); and finally if the enabled third state unit STATE(c) receives the data “c” in the next cycle, then it will generate an output of a logic-HIGH signal which is used as the result message 42 for indicating a match. On the contrary, if the output of the third state unit STATE(c) is a logic-LOW signal, then it indicates that the processing result is a mismatch. Since the DFA is well known and widely utilized technology in the information industry, details thereof will not be further described in this specification

### Operation of the Invention

The following is a detailed description of a practical application example of the dual-stage regular expression pattern matching system of the invention 30 in actual operation. In application, the invention is utilized together with a conventional regular expression pattern matching module to construct a hybrid system for parallel processing of input code sequences of two distinct patterns; i.e., code sequences that have the special pattern α.{n}β described above are processed by the invention, whereas code sequences of other patterns are processed by the conventional method. Preferably, the system of the invention and the conventional system are constructed into a parallel architecture so that input code sequences (such as a stream of network data packets) can be processed in parallel for enhanced performance and reliability.

In the following example, it is assumed that the regular expression database 20 predefines the regular expression “LOGIN[̂\x0a]{100}” as the pattern of a malicious login message (such as an invalid username) that is permitted to gain access to the data processing system 10, and it is further assumed that the data processing system 10 receives a network data packet whose content is “abcLOGIN00000 . . . 000” (one hundred 0s after “LOGIN”). Since the pattern of this network data packet is matched to the special pattern α.{n}β, it is forwarded as an input code sequence 41 to the dual-stage regular expression pattern matching system of the invention 30 for determining whether it is matched to any one of the regular expressions predefined in the regular expression database 20.

In pre-preprocessing, the prefix string “LOGIN” is preset to the prefix string comparison data structure 121 (which is a hash table in this embodiment), while the postfix string “0000 . . . 000’ is preset to one of the state units in the postfix string comparison module 220 (which is a DFA in this embodiment), for example the (j)th state unit DFA(j). During actual operation, the dual-stage regular expression pattern matching system of the invention 30 performs a 2-stage comparison process on the input code sequence 41, including a first-stage comparison procedure M1 and a second-stage comparison procedure M2, as described in the following.

### (M1) First-Stage Comparison Procedure

Upon reception of the input code sequence 41, the dual-stage regular expression pattern matching system of the invention 30 first activates the sequential-scan prefix string extraction module 110 to scan the input code sequence 41 for the first 5 characters, thereby extracting “abcLO” for comparison by the prefix string comparison module 120 with the prefix string comparison data structure 121. Since the result is a mismatch, the sequential-scan prefix string extraction module 110 then scans for the next 5 characters, thereby extracting “bcLOG” for comparison. The result is again a mismatch. The same procedure is repeated until “LOGIN” is extracted and determined to be a match. Next, the second-stage comparison procedure M2 is activated for comparison of the postfix string (note that if the processing result is a mismatch, a mismatch message is promptly outputted as the result message 42).

### (M2) Second-Stage Comparison Procedure

In the second-stage comparison procedure M2, the first step is to activate the postfix string extraction module 210 to extract the postfix string “00000 . . . 000” of the input code sequence 41 and then transfer the extracted data to the postfix string comparison module 220 for further processing. In the postfix string comparison module 220, since the (j)th state unit DFA(j) contains the states of one hundred 0s that are matched to this postfix string “00000 . . . 000”, the output port OUT(j) of DFA(j) will output a logic-HIGH signal indicating the processing result is a match. This output signal is then used as the result message 42 which can be interpreted by the data processing system 10 that the input code sequence 41 is a match to the (j)th regular expression in the regular expression database 20.

Subsequently, the result message 42 is transferred to the data processing system 10 so that the (j)th rule indicated by the result message 42 is used by the data processing system 10 for handling the input code sequence “abcLOGIN00000 . . . 000”.

In addition, for the purpose of enhancing performance, the invention can be implemented in such a manner that at the time the first-stage comparison procedure M1 is completed and the second-stage comparison procedure M2 is started for the currently received network data packet, the first-stage processing unit 100 can be started to process the succeeding network data packet. This pipelined processing scheme can help enhance the overall processing speed.

### Advantage of the Invention

Comparing to prior art, the invention can be used for processing code sequences having a special pattern, namely α.{n}β, without producing an enormous amount of state data that would cause the problem of insufficient memory during operation. The invention is therefore more advantageous for use than prior art.

The invention has been described using exemplary preferred embodiments. However, it is to be understood that the scope of the invention is not limited to the disclosed embodiments. On the contrary, it is intended to cover various modifications and functional equivalent arrangements. The scope of the claims, therefore, should be accorded the broadest interpretation so as to encompass all such modifications and functional equivalent arrangements.

What is claimed is:

1. A dual-stage regular expression pattern matching method for use on a data processing system for processing an input code sequence to check whether the input code sequence is matched to a special pattern of concern, where the input code sequence is of the type having a prefix string and a postfix string which includes a sequence of repetitions of a certain character;
the dual-stage regular expression pattern matching method comprising:
performing a first-stage comparison procedure, which includes a first step of extracting the prefix string of the input code sequence by a sequential-scan manner, and a second step of performing a prefix string comparison process based on a predefined prefix string comparison data structure for determining whether the extracted prefix string is matched to the prefix string of the special pattern of concern; and
performing a second-stage comparison procedure, which includes a first step of extracting the postfix string of the input code sequence, and a second step of performing a postfix string comparison process to check whether the postfix string is matched to the postfix string of the special pattern of concern.

2. The dual-stage regular expression pattern matching method of claim 1, wherein the data processing system is a computer platform.

3. The dual-stage regular expression pattern matching method of claim 1, wherein the data processing system is a firewall.

4. The dual-stage regular expression pattern matching method of claim 1, wherein the data processing system is a network intrusion detention system (NIDS).

5. The dual-stage regular expression pattern matching method of claim 1, wherein the data processing system is a DNA sequence analysis system.

6. The dual-stage regular expression pattern matching method of claim 1, wherein the prefix string comparison data structure is a hash table.

7. The dual-stage regular expression pattern matching method of claim 1, wherein the prefix string comparison data structure is a binary search tree.

8. The dual-stage regular expression pattern matching method of claim 1, wherein the second-stage comparison procedure is implemented with a deterministic finite-state automata (DFA) machine.

9. The dual-stage regular expression pattern matching method of claim 1, wherein the second-stage comparison procedure is implemented with a nondeterministic finite-state automata (NFA) machine.

10. A dual-stage regular expression pattern matching system for use with a data processing system for processing an input code sequence to check whether the input code sequence is matched to a special pattern of concern, where the input code sequence is of the type having a prefix string and a postfix string which includes a sequence of repetitions of a certain character;
the dual-stage regular expression pattern matching system comprising:
a first-stage processing unit, which includes:
a sequential-scan prefix string extraction module for extracting the prefix string of the input code sequence by a sequential-scan manner; and
a prefix string comparison module for performing a prefix string comparison process based on a predefined prefix string comparison data structure for determining whether the extracted prefix string is matched to the prefix string of the special pattern of concern; and
a second-stage processing unit, which includes:
a postfix string extraction module for extracting the postfix string of the input code sequence;
a postfix string comparison module for performing a postfix string comparison process to check whether the postfix string of the input code sequence is matched to the postfix string of the special pattern of concern.

11. The dual-stage regular expression pattern matching system of claim 10, wherein the data processing system is a computer platform.

12. The dual-stage regular expression pattern matching system of claim 10, wherein the data processing system is a firewall.

13. The dual-stage regular expression pattern matching system of claim 10, wherein the data processing system is a network intrusion detention system (NIDS).

14. The dual-stage regular expression pattern matching system of claim 10, wherein the data processing system is a DNA sequence analysis system.

15. The dual-stage regular expression pattern matching system of claim 10, wherein the prefix string comparison data structure is a hash table.

16. The dual-stage regular expression pattern matching system of claim 10, wherein the prefix string comparison data structure is a binary search tree.

17. The dual-stage regular expression pattern matching system of claim 10, wherein the second-stage comparison procedure is implemented with a deterministic finite-state automata (DFA) machine.

18. A dual-stage regular expression pattern matching system for use with a data processing system for processing an input code sequence to check whether the input code sequence is matched to a special pattern of concern, where the input code sequence is of the type having a prefix string and a postfix string which includes a sequence of repetitions of a certain character;
the dual-stage regular expression pattern matching system comprising:
a first-stage processing unit, which includes:
a sequential-scan prefix string extraction module for extracting the prefix string of the input code sequence by a sequential-scan manner; and
a prefix string comparison module for performing a prefix string comparison process based on a predefined hash-table data structure for determining whether the extracted prefix string is matched to the prefix string of the special pattern of concern; and
a second-stage processing unit, which includes:
a postfix string extraction module for extracting the postfix string of the input code sequence;
a postfix string comparison module for performing a postfix string comparison process to check whether the postfix string of the input code sequence is matched to the postfix string of the special pattern of concern.

19. The dual-stage regular expression pattern matching system of claim 18, wherein the data processing system is a network intrusion detention system (NIDS).

20. The dual-stage regular expression pattern matching system of claim 18, wherein the data processing system is a DNA sequence analysis system.
